(19) United States
(12) Patent Application Publication
(10) Pub. No.: US 2005/0190291 A1
(43) Pub. Date: Sep. 1, 2005

(54) Portable data unit

(76) Inventors: Yuichiro Kota, Tokyo (JP); Minoru Ikeda, Inagi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/933,324

(22) Filed: Sep. 3, 2004

(30) Foreign Application Priority Data
Feb. 27, 2004 (JP) 2004-052702

(51) Int. Cl. H04N 5/225

(52) U.S. Cl. 348/376

(57) ABSTRACT

A slide type portable data unit which has satisfactory interior mounting efficiency, having a first casing, a second casing and a slide mechanism portion connecting the first casing and the second casing so that the two casings are slidable in one direction, wherein the slide mechanism portion connects the first casing and the second casing so that the first casing and the second casing have a fore-and-aft relationship, and are taken in a first condition in which the second casing is superposed with the first casing, and in a second condition in which the two casings are displaced from each other in the one direction, and the first casing has one end part, in the one direction, which is not superposed with the second casing in the first condition, and a camera portion is incorporated in this part which is not superposed.

### CLAIM OF PRIORITY

The present application claims priority from Japanese application JP 2004-052702 filed on Feb. 27, 2004, the content of which is hereby incorporated by reference into this application.

### BACKGROUND OF THE INVENTION

The present invention relates to a slide type portable data unit composed of a plurality of casings which are slidably connected to one another so that the portable data unit can have a compact configuration when the casings are retracted into one another, but have a length adjusted to an ear and a mouth of a user when they are extended from one another.

These years, mobile telephones incorporating a camera function, have been prosperously used. Most of these mobile phones have such a deformable configuration that it is compact during carrying by a user but it has a length adjusted to an ear and the mouth of the user during telephone conversation. Most of these conventional examples have been a foldable type, that is, two casings are folded through the intermediary of a connection therebetween. However, these years, there have been proposed those having various configurations.

As an example of these variable configurations, two thin casings which are slidably connected to each other, are superposed with one another during carrying or image pick-up, but are extended from each other so as to obtain a predetermined length during telephone conversation (Refer to, for example, JP-A-2003-3235 and JP-A-2003-110675).

In the above-mentioned conventional example, the thin two casings are slidably coupled to each other, there has been such a severe task that components are appropriately arranged in these casings. That is, for example, should the interior components be not efficiently arranged, the configuration would become large-sized, resulting in deterioration of portability. In particular, the higher the optical telescopic function, the larger the size of the cameral mechanism portion, thus, it has been apprehensive to use the camera function for this configuration in which the two casings are slidable.

Further, should the two casings be slid with no care in this mobile telephone, the mobile telephone would accidentally falls down during telephone conversation, or fingers which hold the casings with a posture during telephone conversion would touch the cheek of the user, causing a posture effective for telephone conversation to be unable to be taken.

### BRIEF SUMMARY OF THE INVENTION

Accordingly, one object of the present invention is to provide a slide type portable data unit incorporating a configuration which has a satisfactory internal mounting efficiency and which is compact.

To the end, according to the present invention, there is provided a portable data unit comprising a first casing, a second casing and a slide mechanism portion for connecting these two casings, slidably in one direction, wherein the slide mechanism portion connects the two casings so as to take a fist condition in which the first casing is superposed with the second casing, the second casing being positioned behind the first casing so that the first and second casings have a fore-and-aft relationship, and a second condition in which the two casings are slid from each other in the one direction, and the first casing has a portion in which one end part thereof in one direction is not superposed with the second casing in the first condition, and in which a camera portion is rotatably incorporated.

With this configuration, a slide type portable data unit having a configuration which has a satisfactory internal mounting efficiency and which is compact.

Other objects, features and advantages of the present invention will be apparent from descriptions which will be made hereinbelow with reference to the accompanying drawings in which:

### BRIEF DESCRIPTION OF SEVERAL VIEWS OF THE DRAWING

FIGS. 1a to 1d are perspective views illustrating a portable data unit (mobile telephone) in accordance with the present invention;

FIG. 2 is a sectional view illustrating the data unit (mobile telephone) according to the present invention;

FIGS. 3a to 3d are external views illustrating the data unit (mobile telephone) having its casings are retracted to each other;

FIGS. 4a to 4c are external views illustrating data unit (mobile telephone) having its casings which are extended from each other;

FIG. 5 is a sectional view illustrating a slide mechanism in the portable data unit (mobile telephone) according to the present invention;

FIG. 6 is a view for explaining a posture for holding the portable data unit (mobile telephone), according to the present invention, with the casings being extended from each other;

FIGS. 7a to 7b are views for explaining a posture for image pick-up by a camera with the casings of the portable data unit (mobile telephone) according to the present invention, being retracted to each other;

FIGS. 8a to 8c are perspective views illustrating a portable data unit (mobile telephone) in a second embodiment of the present invention;

FIG. 9a to 9b are perspective views illustrating a mobile telephone in a third embodiment of the present invention;

FIGS. 10a to 10d are external views illustrating a mobile telephone in the third embodiment of the present invention;

FIG. 11a to 11b are external views illustrating the mobile telephone in the third embodiment of the present invention;

FIGS. 12a to 12c are external views illustrating the mobile telephone in the third embodiment of the present invention;

FIG. 13 is a sectional view illustrating the mobile telephone in the third embodiment of the present invention;

FIGS. 14a to 14c are partly broken external views illustrating the mobile telephone in the third embodiment of the present invention;

FIGS. 15a to 15e are external views illustrating a mobile telephone in a fourth embodiment of the present invention;

FIGS. 16a to 16c are external views illustrating the mobile telephone in the fourth embodiment of the present invention;

FIG. 17a to 17e are external views illustrating a mobile telephone in a fifth embodiment of the present invention;

FIGS. 18a to 18d are partly broken external views illustrating the mobile telephone in the fifth embodiment of the present invention;

FIG. 19a to 19e are partly broken external views illustrating a sixth embodiment of the present invention;

FIGS. 20a to 20c are external views illustrating the mobile telephone in the sixth embodiment of the present invention;

FIG. 21a to 21e are external views illustrating a mobile telephone in a seventh embodiment of the present invention;

FIG. 22a to 22c are external views illustrating the mobile telephone in the seventh embodiment of the present invention:

FIG. 23a to 23e are external views illustrating an eight embodiment of the present invention; and

FIGS. 24a to 24c are external views illustrating the eighth embodiment of the present invention.

### DETAILED DESCRIPTION OF PREFERRED EMBODIMENTS

### First Embodiment

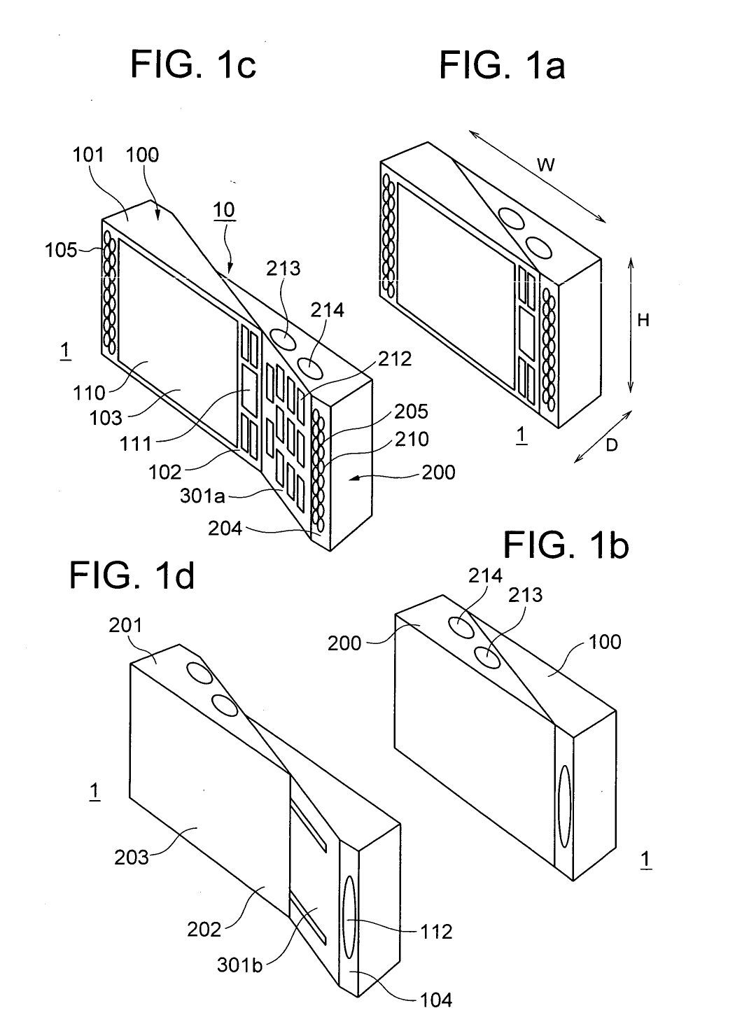

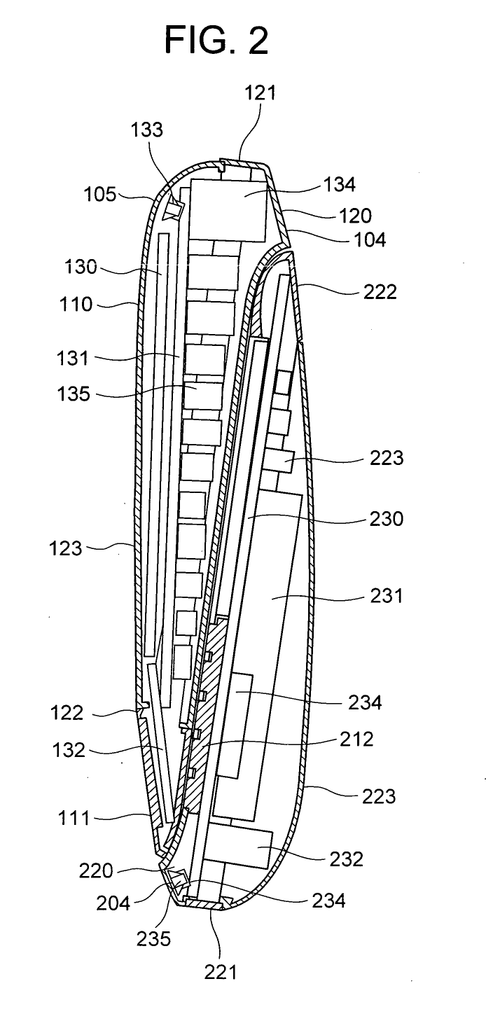

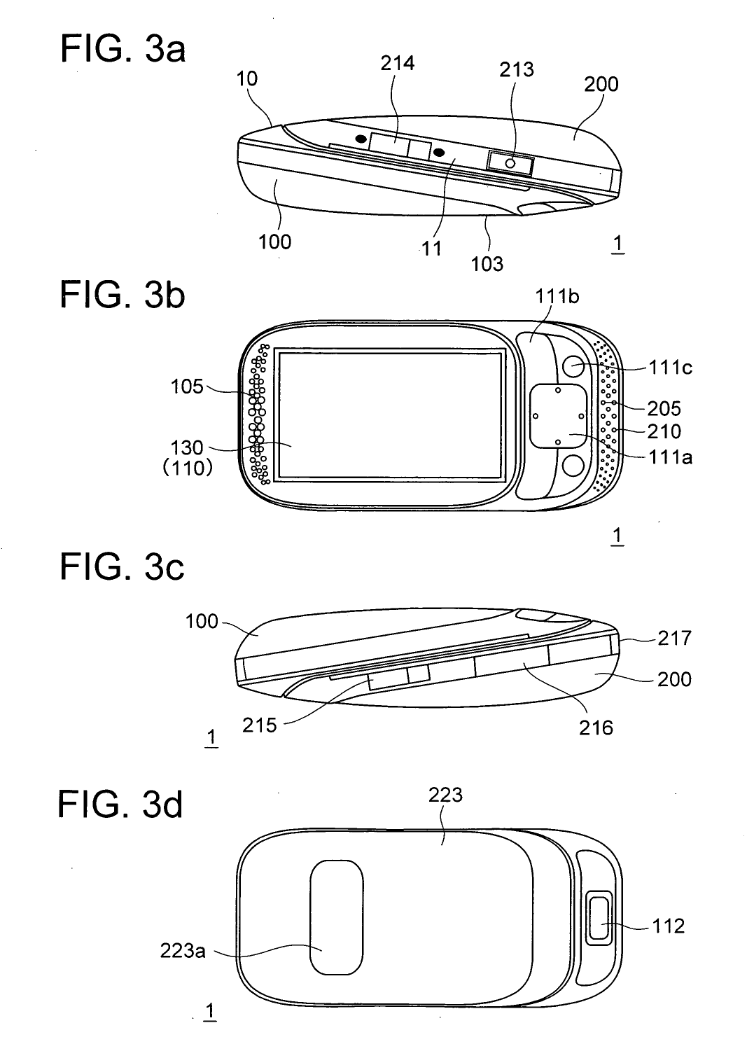

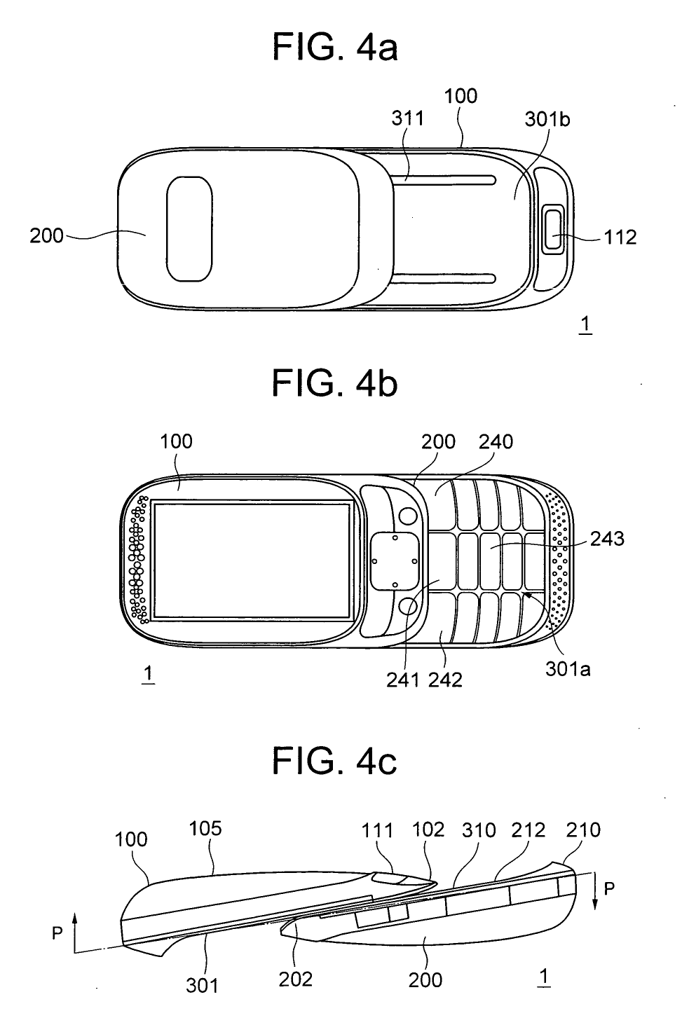

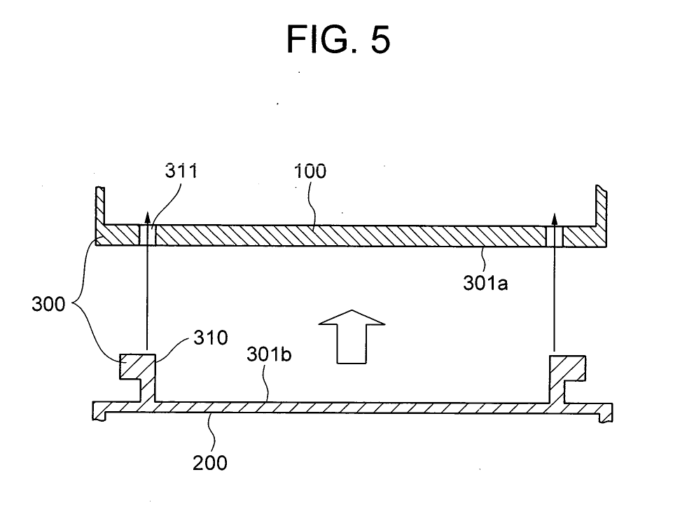

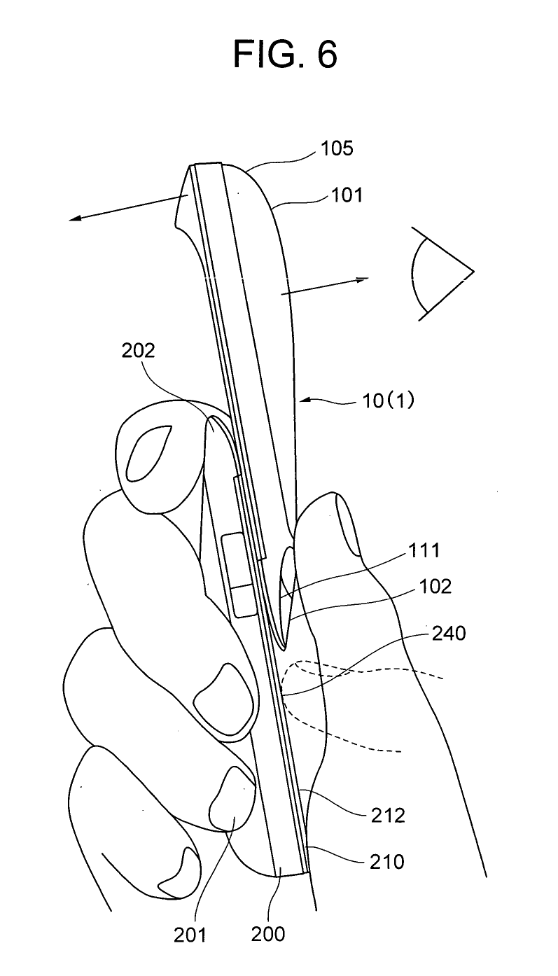

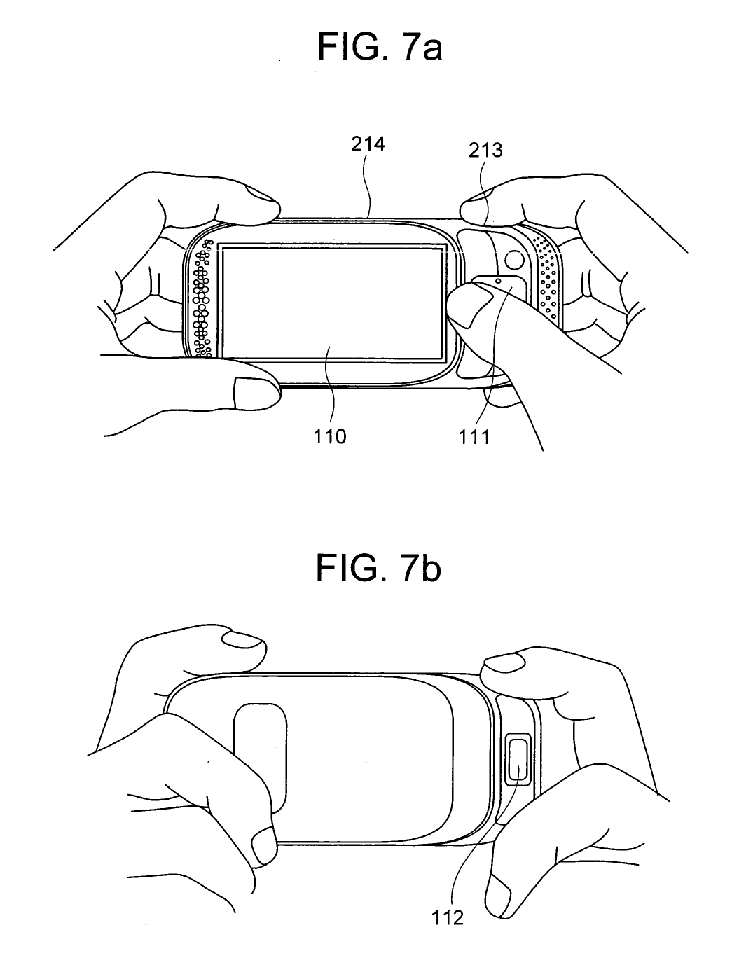

FIGS. 1a to 7b show a portable data unit (mobile telephone) in a first embodiment of the present invention, among which FIGS. 1a to 1d are external views illustrating the portable data unit in various conditions, FIG. 2 is a sectional view illustrating the mobile telephone, FIGS. 3a to 3d are external views illustrating the mobile telephone having its casings which are retracted to each other, FIGS. 4a to 4c are external views illustrating the mobile telephone having its casings which are extended from each other, FIG. 5 is a sectional view illustrating a slide mechanism, FIG. 6 is a view for explaining a holding posture in a condition in which the casings are extended from each other, and FIGS. 7a to 7b are views for explaining a posture for image pick-up by a camera.

At first, explanation will be made of the mobile telephone in the first embodiment with reference to FIGS. 1a to 1d among which FIGS. 1a and 2b are perspective views illustrating the mobile telephone in a first condition in which its casings which are retracted to each other, the front side of the mobile telephone being shown in FIG. 1a while the rear side of the mobile telephone being shown in FIG. 1b, and FIGS. 1c and 1d are perspective views illustrating the mobile telephone in a second condition in which its casings are extended from each other, the front side of the mobile telephone being shown in FIG. 1c while the rear side thereof is shown in FIG. 1d.

The mobile telephone in this embodiment incorporates functions of reproducing images and sounds received from TV broadcastings and the like, and further, serving as a data unit, in addition to the function of telephone conversation. The mobile telephone which is generally indicated by a reference numeral 1, comprises a first casing 100, a second casing 200 and a slide mechanism portion 300 (Refer to FIG. 5) which slidably connect these two casings. In this embodiment, the overall housing 10 consisting of the two casings has a flattened thin parallelepiped shape having a height H which is larger than its depth, and a width W which is larger than the height H.

Further, in this embodiment, the housing is bisected laterally with respect to the width W, obliquely as viewed from the above, so that the two casings have a fore-and-aft relationship along the bisected line. That is, in this embodiment, the bisected part of each of the two casings 100, 200 has a thickness which is small and smaller in a widthwise direction from the one side to the other side, as viewed from the above.

Further, the first casing and the second casings are superposed with each other with their one thicker end side 101 and the other thinner end side 201 being located fore-and-aft, and a plane where these two casings make contact with each other defines a slide plane 301 so as to have a configuration in which the casings are slid in the widthwise W direction of the housing 10. Thus, as shown in FIGS. 1a and 1b, in the first condition in which two casings are superposed with each other (retracted to each other), the housing 10 has a parallelepiped shape or a thin box-like shape, and in the second condition in which two casings are extracted from each other in the widthwise W direction, the housing has a large depth at its opposite ends, but has a small depth in its center part where two casings are overlapped with each other.

Accordingly, the housing can have a shape which is compact and excellent in portability in the first condition, and further, in the second condition in which the casings are extended from each other, it can be deformed into a shape capable of having a length adjusted to an ear and the mouth of a user and having satisfactory holding ability if the extended housing is set in a posture in which the longitudinal direction thereof (widthwise W direction) is set to be vertical.

Further, in this embodiment, in the first condition, a part 204 of the second casing 200 can be arranged on one side of a board surface (front surface) 103 of the first casing 100. This part 204 of the second casing 200 is always located on one side of the broad surface 103 of the first casing 100. That is, even though two casings are extended from each other, the part 204 of the second casing 200 can be located on one side of the first casing 100 in the widthwise W direction.

In this configuration, even in the first and second conditions, a second speaker portion 205 is arranged in the part 204 of the second casing 200 located on one side of the broad surface 103 of the first casing 100, and a second speaker portion 105 is arranged on one side of the first casing 100, which is opposed to the part 204 of the second casing 200 (thicker end side 101). Further, a display portion 110 is arranged in the broad surface 103 of the first casing 100, between the speaker portions 105, 205. Accordingly, even in the first and second conditions, the speaker portions 105, 205 in a pair can be located on opposite sides of the display portion 110. Thus, with the use of the positional relationship among the display part 110 and the speaker portions 105, 205, various images such as images from TV broad castings or reproduced images can be displayed on the display portion 110 while stereophonic sounds can be produced from the speaker portions 105, 205 in a pair located on the opposite sides of the display portion 110. Further, in this embodiment, a function key board 111 is located in the first casing 100 between the display portion 110 and the second speaker portion 205. This function key board 111 includes a plurality of manipulation switches which are frequently used in this mobile telephone 1. Thus, in this embodiment, the function key board 111 is always exposed outside even in the first and second conditions, the mobile telephone can be operated in various modes by means of the function key board 111.

Further, in this embodiment, a receiver portion which is not shown is located on the one side of the first casing 100 (thicker one end side 101), and a microphone portion 210 is located in the part 204 of the second housing 200. With this configuration, in the second condition in which the housing 10 is extended, the receiver portion which is located on one end side of the housing 10 in the longitudinal direction (widthwise W direction) an the microphone portion 210 which is located on the other end side thereof are located at positions respectively adjusted to an ear and the mouth of the user. Meanwhile, the microphone portion 210 is exposed outside even in the first condition, and accordingly, it can be used for sound recording even in the first condition.

Further, in this embodiment, in the first condition, the rear surface side of the first housing 10 also allows the portion 104 of the first casing 100 to be located on one side (the other thinner end side 202) of the second casing 200, similar to the front side as stated above. The part 104 of the first casing 100 is configured so as to be always exposed to the outer surface of the housing 10 even in the first and second conditions. In this embodiment, an image pick-up window 112 for a camera device is formed in the part 104 of the first casing 100. Thus, in this embodiment, even in any one of the first and the second conditions, an image pick-up by a camera can be made with the used of the image pick-up window 112 for the camera device.

Further, in one of the essential features of this embodiment, the camera device can be arranged in rear of the image pick-up window 112, that is, in a deepest part of the first casing 100 (on the thicker one end side 101). Accordingly, it can be cope with a large-sized camera device while an increase in the size of the housing 10 is restrained. That is, a mobile telephone having a conventional slide structure has in general such a configuration that two casings which are bisected in the depthwise D direction are slid in a direction orthogonal to the depthwide D direction. Should a camera device be arranged in this conventional structure, the camera device would be arranged in one of the casings which are bisected in the depthwise direction. Thus, it would cause such a problem that the size of the housing becomes larger as the size of the camera device is inevitably increased. On the contrary, with the configuration of this embodiment, since the camera device can be arranged in the depthwise thick portion of the first casing 100 which corresponds to the depthwise D direction of the housing 10, it can accept therein a large-sized camera device while an increase in the size of the housing 10 is restrained.

Meanwhile, since the function key board 111 is arranged on the one end side of the first casing 100 having a small depth (on the other thin end side 102), a planar manipulation board can be arranged in this thin depth part. Accordingly, in this embodiment, a dead space can be reduced.

It is noted that a battery portion which occupies a large space is arranged in a thick depth part of the second casing 200 (on the one end side 201 having a large thickness) (Refer to FIG. 2) while the board is arranged in a part having a small depth part of the second casing 200 (on the other this side), thereby it is possible to materialize the above-mentioned unique configuration without deteriorating the mounting efficiency of devises.

Further, in this embodiment, a character and numeric input board 212 which is used by the user in the second condition in which a posture for inputting characters and numeric values are taken, is arranged on the slide surface 301a which is exposed outside in the second condition. Accordingly, manipulation keys that are not used in the second condition in which the mobile telephone takes a stowing posture or an image pick-up posture are concealed, and on the contrary, manipulation keys which are used in the second condition can be exposed through the change over from the first condition into the second condition, thereby it is possible to enhance the operability thereof.

Further, a shutter switch 213 and a mode change-over switch 214 are arranged on the thick depth side of the second casing 200 defining an upper surface in the first condition. With this configuration, in the case of image pick-up by the camera in the first condition, the user can manipulate the above-mentioned switches provided in the upper surface while he holds the housing 10 with his right hand. Further, in this embodiment, since the mobile telephone takes a posture in which its longitudinal direction (widthwise W direction) extends laterally, the user can carry out the image pick-up while he holds the laterally opposite end parts of the mobile telephone with his both hands, thereby it is possible to prevent the camera from shaking (blurring). Further, in this embodiment, since the speaker portions 105, 205 are arranged on the opposite end parts, the spaces in which the speaker portions are arranged can be used as grip parts. Thus, it is possible to restrain the hands holding the opposite end parts, from covering the display portion 110 which displays thereon an image to be picked up (Refer to FIGS. 7a to 7b).

Meanwhile, in this embodiment, in the second condition, the image pick-up can be made while the extended end parts are set up and down. In this image pick-up posture, an image pick-up switch is allocated to a specific key in the function key board 111. Thus, the user can carry out the image pick-up with the use of his thumb which holds the second casing 200 while he supports the second casing 200 by his one hand (Refer to FIG. 6).

Thus, in this embodiment, each of the first and second casings has a wedge-like shape having a depth which is decreased gradually from one end to the other end, and accordingly, the first casing 100 defines the front surface and one of opposite side surfaces of the housing 10 while the second casing 200 defines the rear surface and the other of the side surfaces of the housing 10. Further, in this embodiment, since the two casings have the wedge-like shape, one end side part of each of the casings in the longitudinal direction (widthwise W direction) has a thick depth while the other end side can have a sharpened end part. With this configuration, an internal mounting space having an extra space in the depthwise D direction can be ensured in the inside of the above-mentioned thicker side part. With the use of this extra inner mounting space, interior components having thick depths can be accommodated. In particular, since these years, portable mobile data units incorporate camera devices having increased sizes, a large-sized cameral device corresponding to the depth D of the housing 10 can be mounted.

Meanwhile, the sharpened end side part can define a space for arranging an operation board or a control board having a relative small thickness, and further, a height of a step part which is defined between the first casing 200 and the second casing 200 when the first casing 100 and second caring 200 are extended from each other in the widthwise W direction can be reduced.

Further, in a condition in which the wedge-like two casings are extended from each other, there may be obtained in a satisfactory posture of telephone conversation in which the opposite end parts in the longitudinal direction (the widthwise W direction) are thick (the depth D is large) while the center part is thin.

Referring to FIG. 1d, there is shown a slide surface 301b of the first casing 100 which is exposed outside when the two casings are extended from each other.

Detailed explanation will be made of the portable telephone in this embodiment, with reference to FIGS. 2 to 7b. It is noted that FIGS. 1a to 1d schematically show the mobile telephone 1 in a straight-like like or angular shape for the sake of brevity for explanation, but FIGS. 2 to 7b show the mobile telephone having an external shape which can be applied to the implemented product.

At first, referring to FIG. 2, explanation will be made of the configuration of arrangement of the interior components. In FIG. 2, in this embodiment, the first and second casings are composed of inner covers 120, 220 which define the slide plane 30, and outer covers 121, 221 for covering the outside of the housing 10.

The inner cover 120 of the first casing 100 incorporates the slide surface 310a and the part 104 of the first casing 100 adapted to always exposed to the rear surface side of the housing 10. Meanwhile, the outer cover 121 of the first casing 100 covers the front surface side of the first casing 100 in its entirety, and is arranged in its front surface with the function key board 111, the display portion 110 and the first speaker portion 105. The inner cover 120 and the outer cover 121 are connected by means of a partition groove formed in the peripheral side surfaces (upper and lower surfaces, and a left side surface) of the first casing 100, and are fixed together with screws which are not shown. Further, the outer cover 121 is composed of a base casing 122 serving as a base for the outer cover 121, and a transparent decorative cover 123 which is formed so as to separate a part of the base casing 122, that is, the display part 110 and the first speaker portion 105 from other exteriors. It is noted that the decorative cover 123 is transparent in a part corresponding to the display part 110, and is internally coated with paint in the other peripheral part so as to enhance the aesthetic appearance.

Further, in the second casing 200, similar to the first casing 100, the inner cover 220 incorporates the slide surface 301b and the part 204 of the casing 200 which is always exposed to the front surface side of the housing 10, and the outer cover 221 of the second casing 200 is composed of a base casing 222 serving as a base for the outer cover 221, and a battery cover 223 removably attached to the base casing 222 so as to cover a part of the latter.

In this embodiment, in order to efficiently arrange interior components in the space having a substantially triangular sectional shape, a corner part of the front surface side or the rear surface side of the broad surfaces 101, 201 of the first casing 100 is chamfered so as to have a gentle rounded shape. Further, it has a continuous shape from the other thin end side 102, 201 to the parts 104, 204 of the two casings which are connected by gentle curved surfaces. Meanwhile, as shown in FIGS. 3b and 3d, the four corners are rounded.

Thus, this mobile telephone 1 has the housing 10 having its external shape whch is like to a piece of soap having rounded four corners, and accordingly, it can be held being substantially set within a hand when it is gripped by the hand, thereby it is possible to have a configuration which is compact and excellent in the holdability. In particular, in this embodiment, the mobile telephone can be held being snuggly fitted in the hand even though one end side of the housing 10 is held by one hand or the opposite end sides are held by both hands so as to carry out image pick-up in a posture in which the longitudinal direction (widthwise W direction) is extended laterally. Further, with such a configuration that is rounded and compact, it can be easily stowed in a pocket. Further, since the corner parts where the accommodation of interior components is difficult are chamfered, it is possible to provide a configuration which is excellent in portability without deteriorating the interior mounting efficiency.

Further, in this embodiment, as shown in FIGS. 3a and 3b, a bumper part 11 is formed along the slide plane 301 which obliquely bisects the housing 10, and functional components are concentrically arranged in this bumper part 11. For example, in the upper surface in FIG. 3a, the shutter switch 213 and the mode change-over switch 214 are arranged, and in the bottom surface in FIG. 3c, a manner mode setting key 215 and an external connection terminal portion 232 covered with an external connection terminal cover 216 are arranged while a charge terminal portion 217 is provided in the right surface side which is not shown. The external connection terminal portion 232 is exposed outside by removing the external connection terminal cover 216, and insertion of a memory medium such as a memory card, and connection to an external equipment or the like can be made. The functional components arranged in this corner part 11 are attached to a second board 230, thereby it is possible to enhance the assembling ability and to shorten the length of wirings.

Further, referring to FIG. 3b, in this embodiment, the mobile telephone incorporates a tuner which can receive ground wave broadcastings and which is not shown. In order to accept the ground wave broadcastings, the display portion 110 utilizes a liquid crystal device 130 having an aspect ratio of 16:19. Further, in this embodiment, a screen change-over switch which is operated in association with the operation of a slide mechanism portion 300 and which is not shown is incorporated, and accordingly, in response to the operation of the screen change-over switch, a horizontally long screen is displayed in the first condition as shown in FIG. 3a, but a vertically long screen is displayed in the second condition as shown in FIGS. 4a to 4c.

Accordingly, in the first condition shown in FIG. 3a, a ground wave digital broadcasting can be seen and listened through a satisfactorily horizontally long screen. Further, since the speaker portions 105, 205 are arranged on the opposite end sides of the display portion 110, and accordingly, the mobile telephone can be used as a small-sized TV.

Further, in this embodiment, in the first condition as shown in FIG. 3a, the function key board 111 through which manipulation is made for the ground wave digital broadcastings is arranged, adjacent to the display portion 110. In this configuration, a menu screen or any one of various selection display screens is displayed on the display portion 111 by manipulating the function key board 111, and by selecting one of various icons or function keys displayed on the display portion 111, one of the broad castings can be determined.

The above-mentioned function key board 111 is composed of a cursor determination key 111a located in the center part thereof and a pair of selection keys 111b, 111c formed on opposite sides of the former. The cursor key determination key 111a has a rectangular key shape so as to have four sides, Thus by depressing one of the four sides of the key 111a, a cursor displayed on the display portion 111 can be moved in the depressed direction, and further by depressing the center of the key 111a, one of functions which are allocated to the various icons and the function keys can be performed through the selection by the cursor.

Meanwhile, by depressing the upper or lower parts of one of the pair of selection keys 111b, 111c around the center as a fulcrum, one of various functions can be selected. For example, by depressing one of the upper and lower parts of the selection key 111b, a function which is set in accordance with a function key displayed on the adjacent display portion 111 can be selected while a network key and a mail key are allocated to the upper and lower parts of the selection key 111c upon initial setting.

Referring to FIG. 3d, the battery cover 223 is attached so as to slidable in the right side direction in the widthwise W direction, and is formed therein with a hand grip recess 223a for displacing the battery cover 223.

Further, referring to FIGS. 4a to 4c among which FIG. 4a is a rear view, FIG. 4b is a front view and 4c is a bottom view, explanation will be made of the external shape of the mobile telephone in the second condition in which the two casings are extended from each other. It is noted that in this second condition, the mobile telephone is used by holding up and down the opposite ends thereof in the longitudinal direction.

Referring to FIGS. 4a to 4c, this embodiment incorporates the slide mechanism portion 300 for extending the two casings from each other along the slide plane 301. An example of this slide mechanism portion is shown in FIG. 5.

Referring to FIG. 5 which is a schematic view illustrating the structure of the slide mechanism portion 300, the upper side corresponds-to the first casing 100 while the lower side corresponds to the second casing 200. A pair of slide projections 310 are formed on the slide surface 301b of the second casing 200, and slide channels 311 are formed in the slide surface 301a of the first casing 100, corresponding to the pair of protrusions 310. The slide projections 310 are fitted in the slide channels 311 and are prevented from being removed from slide channels 311 by means of pegs formed on the front ends of the protrusions 310.

The slide channels 311 are formed by a long length in the widthwise W direction, and further, the slide protrusions 310 fitted in these slide channels 311 are also formed by a long length in the widthwise W direction. With this configuration, two casings can slide in the widthwise W direction, but cannot be displaced in other directions. Further, the corresponding to a variation from the condition shown in FIG. 3a into the condition shown in FIG. 4a.

Referring to FIG. 4b, in this embodiment, the main purpose of the second condition is adapted to carry out a telephone function or a mail function. Accordingly, function keys used for the telephone and mail functions are set in the character and numeric input key board 212 located on the slide surface 301a which is exposed outside in the second condition. For example, in this embodiment, the character and numeric input key board 212 is composed of a power source ON/OFF key, communication ON/OFF key 240 for displaying a standby state on the display portion 110, a clear key 241, a communication key 242 and numeric/character keys consisting of a plurality of keys.

Naturally, also in this condition, image pick-up by the camera device 134 can be made. In order to carry out the image pick-up by the camera device, by manipulating the cursor determination key 111a, the menu screen is displayed, and then by selecting a camera pick-up mode, the pair of the selection keys 111b are set to the camera image-up function keys. Accordingly, by manipulating these keys, the image pick-up by the camera device can be carried out.

Referring to FIG. 4c, since the two wedge-like casings are mated with each other so as to be slidable to each other, they provide an optimum configuration for the telephone function in the second condition. That is, in the configuration which has been conventionally used as a hand-set, a microphone portion 210 and a speaker portion (first speaker portion 105) are projected toward the user from a holding part with which the hand-set is held. This is because the hand-set must be surely held even though the microphone portion 210 and the speaker portion are made into close contact with an ear and the mouth of the user. In this embodiment, the mobile telephone can have a configuration similar to that of the conventional hand-set through change-over from the first condition into the second condition.

That is, in this embodiment, since the first speaker portion 105 rises up toward the user (upward of the figure), with respect to the extension P from the slide plane 301 in which the microphone portion 210 is located, the plane in which the microphone portion 210 and the first speaker portion 105 are arranged can be extended toward the user, with respect to the longitudinal center, similar to the conventional one. Further, since the function key board 111 and the character and numeric input board 212 are assembled in the form of a group of keys lined-up in the center part so as to enhance the operability since the other thin end side 102 of the first casing 100 is continuous to the extension P with a reduced step height.

Meanwhile, the part in which the microphone portion 210 is arranged is extended, being opposite to the user (downward of the figure). That is, in this embodiment, since the rear part of the microphone portion 210 rises up being opposite to the user (downward of the figure), with respect to the extension P of the slide plane 310 in which the image pick-up window 112 is formed, the rear part of the microphone portion 210 and the surface where the image pick-up window 112 is formed can be extended toward the user, with respect to the longitudinal center. Further, since, in the center part, the other thin end side 202 of the second casing 200 is continuous to the extension P with a reduced step height, the rear surface of the second casing 200 can define a continuous holding surface, the posture of telephone conversation and the posture of mail input can have effective holdability.

Next, referring to FIGS. 6 to 7b, explanation will be made of the manner of using the mobile telephone in this embodiment. At first, referring to FIG. 6, the power source of the mobile telephone 1 can be turned on by depressing the communication ON/OFF switch 240 for a relatively long time in order to set up a receiving standby state. Further, the power source can be turned off by depressing again the communication ON/OFF switch 240 for a relative long time.

In the second condition in which the power source is turned on, the mobile telephone 1 is held with the posture as shown in FIG. 6 while the character and numeric input key board 212 and the function key board 111 can be manipulated by a thumb as indicated by the dotted line. This manipulation by the thumb is satisfactory since the surface where the function key board 111 is arranged rises up and is continuous to the surface where the character and numeric input key board 212. Further, the one end side 201 of the second casing 200 having a large thickness on the rear side thereof can be stowed within the palm while the housing 10 can be hold with such a posture that the other thin side 202 is held by a forefinger, and accordingly, the holdability in the second condition can be satisfactory.

In the condition shown in FIG. 6, since the manipulation by the thumb is satisfactory while the second casing 200 is completely and surely held within the palm, thereby it can be expected to reduce camera-shaking or blurring in comparison with a mobile telephone incorporating a conventional slide mechanism. Further, in this embodiment, by shifting the thumb from the second condition shown in FIG. 6 toward a side surface of the housing 10, the posture of telephone conversation can be taken. With this posture of telephone conversation, the function key board 111 and the character and numeric input board 212 can be restrained from touching with the cheek of the user even though the microphone portion 210 and the first speaker portion 105 (receiver portion) are set adjacent to the mouth and an ear of the user.

Next, referring to FIGS. 7a to 7b, the manner of using in the first condition. FIGS. 7a to 7b are views which show the posture holding opposite ends of the mobile telephone 1 in the longitudinal direction (widthwise W direction) with both hands, among which FIG. 7a shows the mobile telephone 1 which is viewed from the front side (the user side), and FIG. 7b shows the mobile telephone 1 which is viewed from the rear side (the objective side).

In this embodiment, the housing 10 can be surely held with the middle fingers of both hands being located below the rear surface of the housing 10, the forefingers on the upper surface side thereof and the thumbs thereof on the front surface side. Further, with this holding posture, the function key board 111 can be manipulated by the thumb of the right hand while the shutter switch 213 and the mode change-over switch 214 can be manipulated by the forefinger of the right hand. Further, with the holding posture shown in FIG. 7a, image pick-up or monitoring of a picked-up image can be made without concealing the image pick-up window 112 and the display portion 110 by fingers.

### Second Embodiment

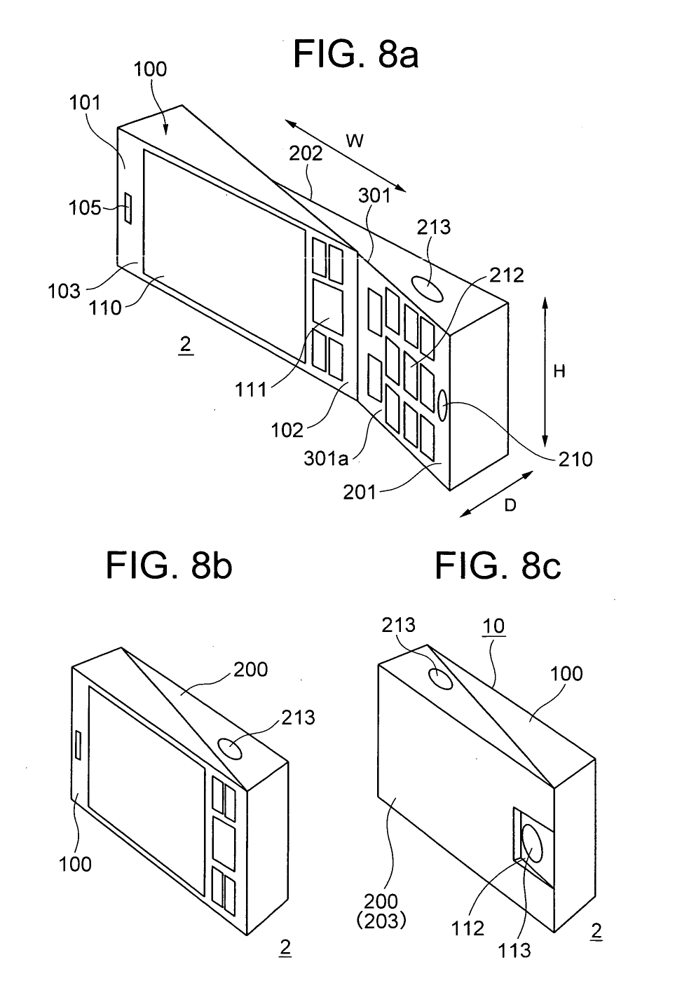

FIGS. 8a to 8b are external views which show a portable data unit (mobile telephone) in a second embodiment of the present invention, among which FIG. 8a is a perspective view illustrating the mobile telephone as viewed from the front surface side in the second condition, FIG. 8b is a perspective view illustrating the mobile telephone as viewed from the front side in the first condition, and FIG. 8c is a perspective view illustrating the mobile telephone as viewed from the rear surface side in the first condition.

Referring to FIG. 8a to 8c, the mobile telephone which is generally denoted by 2, incorporates a first casing 100, a second casing 200 and a slide mechanism portion 300 through which these two casings are slidably connected. In this configuration, the housing 10 consisting of these two casings is basically in the form of a thin flattened parallelepiped body so as to have its height H greater than its depth D and its width W greater than its height H. The upper surface of the body having a substantially rectangular shape, as viewed from the upper surface of the mobile telephone, is divided fore and after by a diagonal line into the front portion and the rear portion which correspond respectively to the first casing 100 and the second casing 200. These two casings are slid in the widthwise W direction through the intermediary of the above-mentioned slide mechanism portion 300 provided in a slide plane 301 by which two casings are divided from each other.

Thus, in this embodiment, each of the first and second casings has a thickness which is gradually decreased from one side to the other side in the widthwise W direction of the housing 10, and the first and second casings are superposed with each other so their thick end sides 101, 201 and the other thin end sides 102, 201 are located fore and aft, and are slid from each other along a slide plane 301 where two casings are made into contact with each other. Accordingly, in a first condition in which the two casings are superposed with each other, the housing 10 has a thin flattened box-like shape while in a second condition in which the two casings are extended from each other in the widthwise direction, the widthwise opposite ends have a thick depth but the center part where both casings are overlapped with each other has a thin depth.

Thus, the housing 10 has a shape excellent in portability in the first condition, and further, in the second condition in which the casings are extended from each other, the housing can be deformed into such a shape that the housing which has been extended can have a length adjusted to an ear and the mouth of a user by holding the housing with its longitudinal direction up and down and is excellent in holdability.

Further, in this embodiment, a display portion 110 is incorporated in the center part of a broad surface 103 (front surface) of the first casing 100, and a first speaker portion 105 and a receiver portion (which is not shown) are arranged in its end side having a thick depth while a function key board 111 is arranged on its tapered end side.

Further, an image pick-up window 112 or a cutout part for a camera is formed in a wide surface 203 (rear surface) of the second casing 200 in the tapered side end part (the other thin end side) thereof. Further, a character and numeric key board 212 and a microphone portion 210 are arranged in a slide surface 301a of the second casing 200 which is exposed outside when the two casings are extended from each other while a lens portion 113 of a camera device 134 is arranged in a slide surface 301a of the first casing 100. This lens portion enables image pick-up even in the first condition since it is superposed with the image pick-up window or the cutout for the camera.

Further, a shutter switch 213 is arranged in a surface of the second casing 200 which defines the upper surface in the first condition, on the thick depth side thereof. With this condition, if image pick-up is made in the first condition, the shutter switch 213 arranged in the upper surface can be manipulated while the housing is held by the right hand.

Thus, in this embodiment, the first casing 100 defines the front surface and one side surface of the housing 10 while the second casing 200 defines the rear surface and the other side surface of the housing 10 as the each of two casings has a wedge-like shape having a depth which is tapered from one end to the other end. Further, in this embodiment, each of the casings having a wedge-like shape has such a configuration that its one end in the longitudinal direction thereof has a thick depth while the other end has a tapered tip end. With this configuration, an internal mounting space having an extra depth can be ensured in the inside on the thick depth side, and accordingly, interior components having a thick depth can be mounted with the use of this internal mounting space.

Meanwhile, a space for arranging an operation board and a control board having a relatively small thickness can be ensured on the tapered tip end side. Further, a step height which is defined between the first and second casings when they are extended from each other in the widthwise direction can be reduced.

Further, in the condition in which the wedge-like two casings are extended from each other, the housing 10 has a configuration which can give such a satisfactory posture of telephone conversation that its longitudinal opposite ends are thick (having a thick depth) while its center is thin.

### Third Embodiment

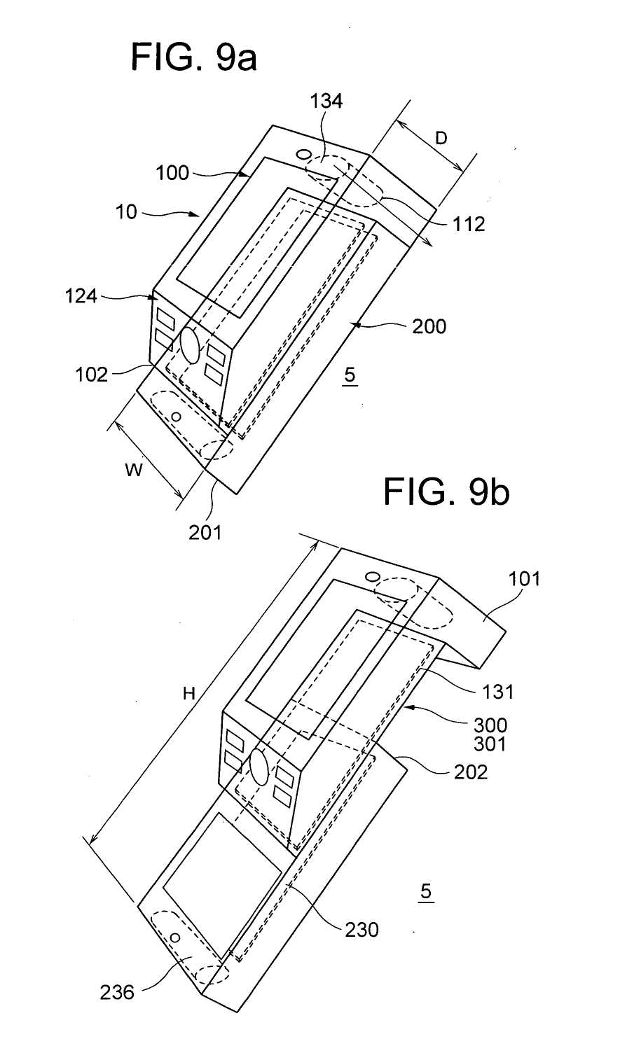

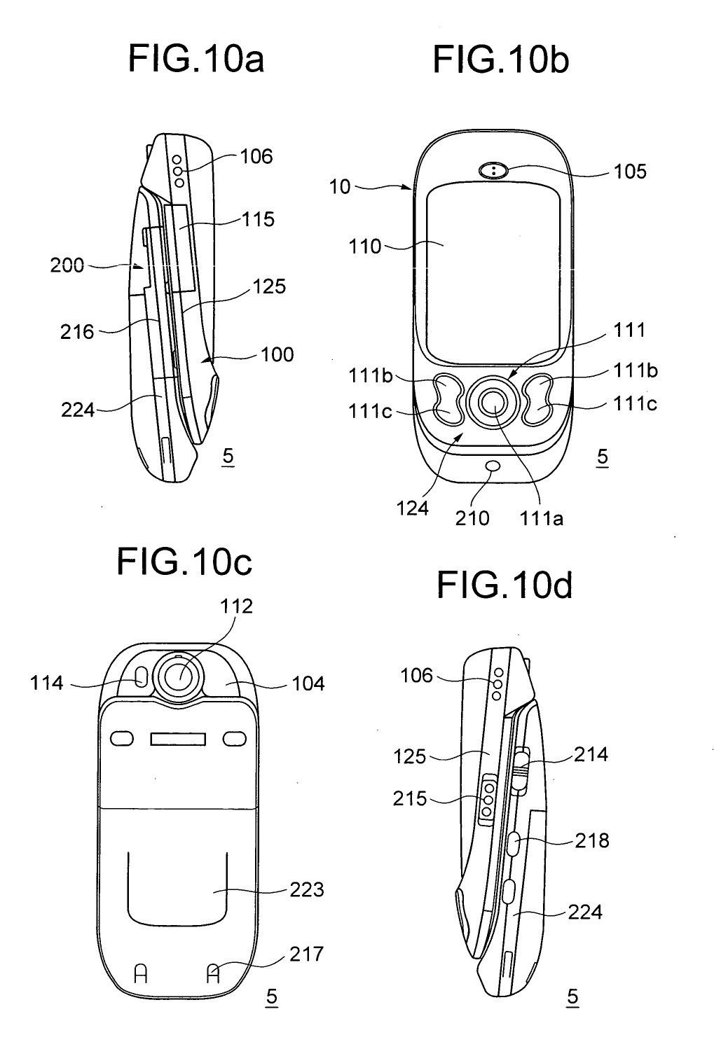

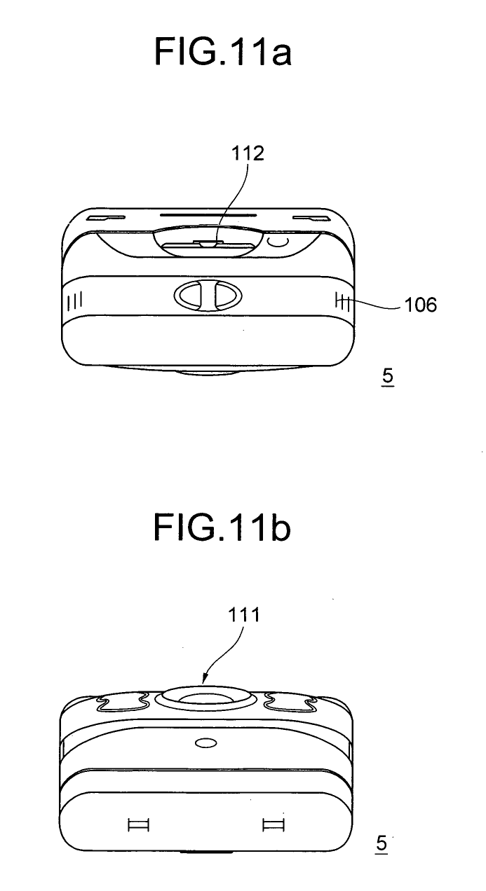

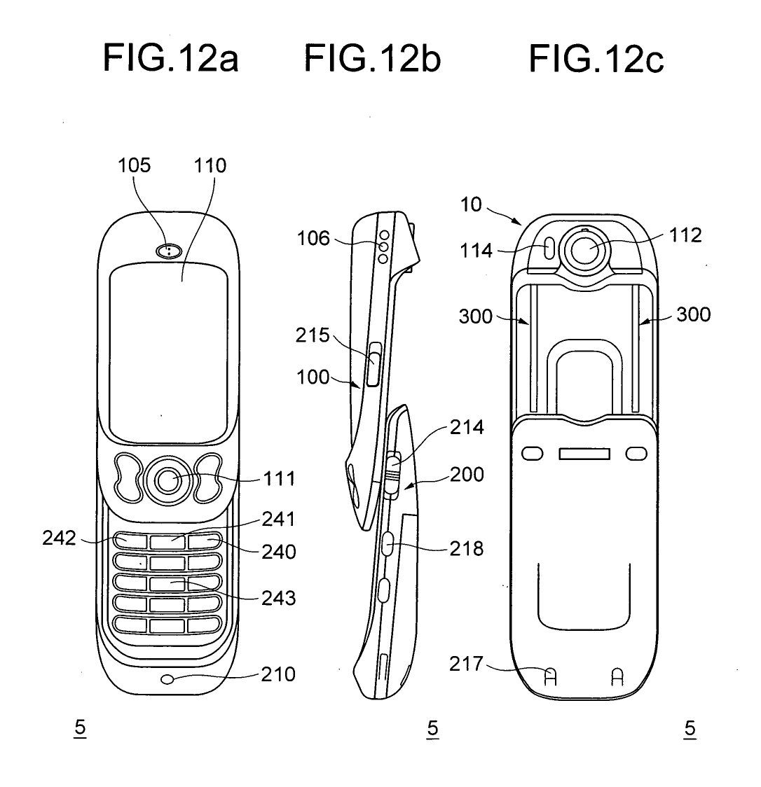

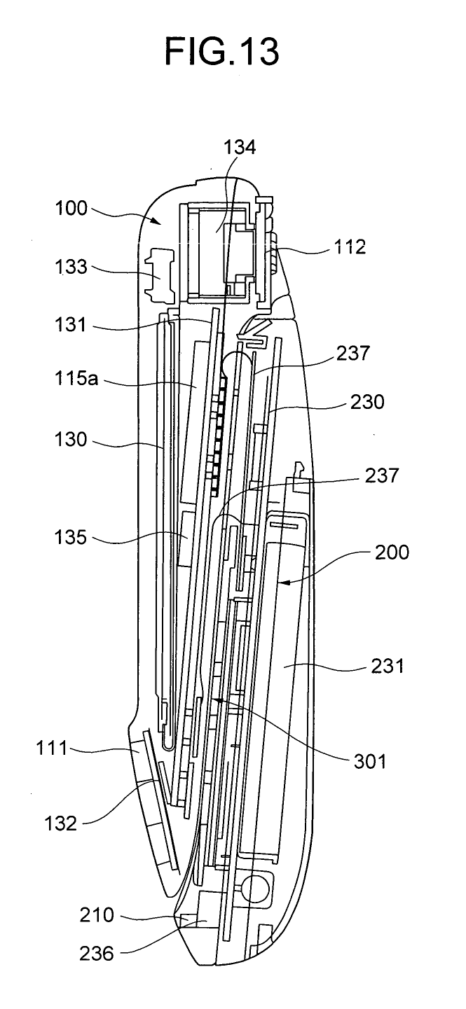

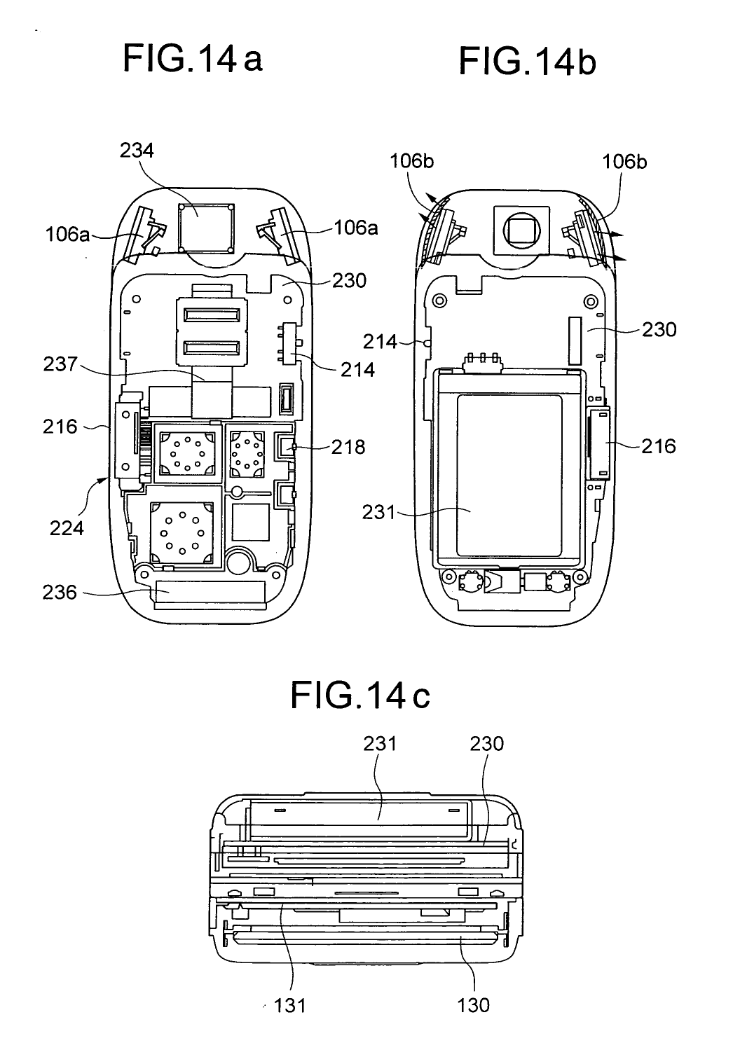

Next, explanation will be made of a mobile telephone in a third embodiment of the present invention with reference to FIGS. 9a to 14 among which FIGS. 9a to 9b are conceptual views illustrating the mobile telephone, FIG. 10a to FIG. 11b are external views illustrating the mobile telephone in a first condition, FIGS. 12a to 12c are external views illustrating the mobile telephone in a second condition, and FIG. 13 to FIG. 14c are sectional views illustrating an internal configuration of the mobile telephone. It is noted that like reference numerals denote like parts and directions to those in the afore-mentioned embodiments in order to abbreviate double explanation.

Explanation will be made of the general configuration of this embodiment with reference to FIGS. 9a to 9b which show a conceptual configuration of the mobile telephone 5 which is used with its longitudinal direction being set up and down in a fundamental posture, and which mainly has a communication function while it also has a camera function. Further, the basic configuration is similar to that of the first embodiment.

That is, the mobile telephone which is generally denoted by reference numeral 5 incorporates a first casing 100 and a second casing 200 and a slide mechanism portion 300 for slidably connecting these two casings. In this embodiment, a housing 10 consisting of the two casings basically has a thin flattened parallelepiped body which is vertically long and which has its width W greater than its depth D and its height H greater than the height W.

In this embodiment, the second casing 200 is superposed with the first casing 100, in rear of the first casing 200. These two casings are shifted from each other up and down, that is, the upper end 101 of the first casing 100 is projected upward from the upper end 202 of the casing 200 while the lower end 201 of the second casing 200 is projected from the lower end 102 of the first casing 100. The parts of the two casings which are overlapped with each other define a slide plane 301 where the slide mechanism portion 300 is provided. Thus, the two casings are slid from each other in the height H wise direction through the intermediary of the slide mechanism portion 300.

Accordingly, in the configuration of the embodiment, as shown in FIGS. 9a and 9b, the mobile telephone has a compact shape having a small height H in the first condition in which the two casings are superposed with (retracted to) each other, but it has a size (length) adjusted to an ear and the mouth of the user in the second condition in which the two casings are extended from each other in the height wise H direction.

Further, as one of the essential features of this embodiment, the camera device 134 and an antenna 236 can be accommodated in the vertically projected parts of the two casings which are not overlapped with each other. The camera device 134 can be prevented from being blocked by the second casing 200 even though the image pick-up window 112 for the camera device 134 is formed in the rear part of the part 101 of the first casing 100 which is projected upward, and the antenna 236 can be prevented from being shielded from radio waves to be received by the first casing 10, thereby it is possible to enhance the efficiency of transmission.

In addition, as shown in FIGS. 10a to 14 which show the mobile telephone 5 in an actual form in comparison with FIGS. 9a and 9b which schematically show the mobile telephone, the mobile telephone 5 is composed of the two casings which have a wedge-like shape, and accordingly, even though the cameral device 134 and the antenna 236 are arranged in the vertically projected parts having the thick depth D, it is possible to restrain the size thereof from being increased. Thus, technical effects and advantages similar to those of the first embodiment can be obtained.

As one of the features of this embodiment, the lower end 102 of the first casing 100 adjacent to the downward projected part 201 of the second casing 200 defines an inclined surface 124. With this configuration, if the user holds with his one hand in the first condition, he can facilitate such a push-up motion that the thumb of the one hand holding the mobile telephone is pressed against the inclined surface 124 in order to push up the same, and accordingly, the mobile telephone can be changed from the first condition into the second condition by his one hand.

Further, one of the essential features of this embodiment is the provision of the interior arrangement in which circuit boards (a first circuit board 131 and a second circuit board 230) incorporated in the first casing 1 and the second casing 2 are arranged in parallel with the slide plane 301. With this configuration, various switches attached to the circuit boards are arranged in bumper parts 125, 224 of the two casings (Refer to FIGS. 10a to 10d) so as to surround the slide plane 301, thereby it is possible to facilitate the manipulation of the switches and to enhance the aesthetic appearance or the assembling ability.

Additional explanation will be made with reference to FIGS. 10a to 14c among which FIGS. 10a to 10d and FIGS. 11a to 11b are external views illustrating the mobile telephone in the first embodiment, that is, FIG. 10a is a left side view, FIG. 10b a front view, FIG. 10c a rear view, FIG. 10d a right side view, FIG. 11a a plan view and FIG. 11b a bottom view, and FIGS. 12a to 12c are external views illustrating the mobile telephone in the second condition, that is, FIG. 12a is a front view, FIG. 12b a right side view and FIG. 12c a rear view.

Referring to FIGS. 10a to 11b, also in this embodiment, similar to the first embodiment, the housing 10 has a thin box-like shape which resembles to the external appearance of a piece of soap having rounded corners, thereby it is possible to obtain technical effects and advantages similar to those of the first embodiment.

The display portion 110 is arranged at the center of the broad surface (front surface) 103 of the above-mentioned first casing 100, and the first speaker portion 105 is arranged above the display portion 110 while the function key board 111 is arranged in the inclined surface 124 defined below the display portion 110. Meanwhile, the image pick-up window 112 and a photographic illumination flush 114 are provided in the part 104 of the first casing 100 which is always exposed outside on the rear surface side of the housing 10.

Various switches are arranged in the bumper part 125 formed around the first casing 100. The above-mentioned bumper 125 is formed so as to be continuously extended from the inclined surface 124 to the opposite side surfaces and the upper surface of the first casing so as to surround the display portion 110, and accordingly, it is distinguished, as a manipulation zone from the display zone. A pair of second speakers 106 for listening music are arranged in the upper parts of the opposite side surfaces, and a memory card insertion part 115 defined in an openable cover is provided in the left side surface while a manner mode setting key 215 is provided in the right side surface. The above-mentioned function key board 111 is composed a circular cursor determination key 111a arranged at the center thereof, and a pair of selection keys 111b, 111c arranged on the opposite sides of the cursor determination key 111a.

Meanwhile, the above-mentioned second casing 200 is provided with a mode change-over switch 214 and a pair of setting keys 218 in the right side surface of the above-mentioned bumper part 224, and is also provided with an external connection terminal cover 216 for covering external connection terminals in the left side surface of the bumper part 224. A shutter key and a zoom key are set to the above-mentioned setting keys 218 in the image pick-up mode. Further, a microphone portion 210 is arranged in the part 204 of the second casing 200 which is always exposed outside on one side of the broad surface (front surface) 103 of the first casing 100.

Referring to FIGS. 12a to 12c, even in this embodiment, the two casings can be extended from each other by means of a slide mechanism portion 300 similar to that shown in FIG. 5 along the heightwise H direction so as to be set into the second condition. In this second condition, since numeric character keys 243 and a telephone conversation key 242 which are provided in the slide surface 301b of the second casing 200 are exposed to the outside, phone calling and transmission of e-mails can be made by means of these keys.

Next, explanation will be made of the arrangement configuration of an internally mounted mechanism with reference to FIGS. 13 and 14a to 14c among which FIG. 13 is a longitudinal sectional view illustrating the mobile telephone, FIG. 14a a sectional view illustrating the second circuit board 230 as viewed from the slide surface 301 side, FIG. 14b a sectional view illustrating the second circuit board 230 as viewed from the rear surface side, and FIG. 14c is a cross-sectional view.

Referring to these figures, as stated above, similar to the first embodiment, the two casings have a wedge-like shape. Accordingly, as shown in FIG. 13, since the first casing 100 has such an external appearance that the depth D of the upper part thereof is greater than the depth D of the lower part, the above-mentioned camera device 134 can be arranged with the use of the space therein. Meanwhile, since the second casing 200 has such a configuration that the depth D of the lower part thereof is greater than the depth D of the upper part, a battery portion 231 and an antenna 236 can be arranged with the use of the space therein.

In particular, the above-mentioned antenna 236 is arranged so that the longitudinal direction of the antenna 236 is extended along the widthwise W direction, and accordingly, the antennal 236 is always projected outward, irrespective of the first or second condition, thereby it is possible to enhance the transmission efficiency.

Meanwhile, the first circuit board 131 as a main circuit board and the second circuit board 230 are arranged in parallel with the slide plane 301. With this configuration, several switches attached to the first and second circuit boards are provided in the bumper parts so as to surround the above-mentioned slide plane 301, thereby it is possible to facilitate the manipulation of the switches and to enhance the aesthetic appearance and the assembling ability.

Further, in this embodiment, with the use of a clearance defined between the above-mentioned first circuit board 131 and the liquid crystal device 130, the memory card 115a is inserted therein, thereby it is possible to directly mount the same to the first circuit board 131.

Further, in this embodiment, since the two casings are displaced from each other along the slide plane 301, wiring to the above-mentioned two circuit boards can be facilitated if the two circuit boards are arranged in parallel to each other. That is, as shown in FIGS. 13 and 14a, in this embodiment, the two circuit boards are connected with each other by means of two wirings having extra lengths, thereby it is possible to prevent the wirings from being broken even in either the second condition in which the two casings are extended from each other or the first condition in which the two casings are retracted to each other.

Further, as shown in FIGS. 14a to 14b, even though the above-mentioned mode change-over switch 214, the setting key 218 and the external terminals covered thereover with the external terminal cover 216 are directly attached to the circuit board 230, these switches are arranged in the bumper part 224, thereby it is possible to enhance the aesthetic appearance and the handling ability.

Further, the pair of speaker portions 106 are arranged on opposite sides of the camera device 134. In this embodiment, similar to the first embodiment, image pick-up by a camera, enjoyment of images through the display portion 110 and listening of music from the second speaker portions 106 can be made with such a posture that the longitudinal direction of the housing 10 is extended in a horizontal direction in which the housing 10 is basically faced upward in FIG. 12d. In this horizontal posture, the pair of speaker portions 106 are arranged up and down, and accordingly, satisfactory stereophonic sound effect can be obtained. Accordingly, as shown in FIG. 14b, in this embodiment, sound radiation holes 106b provided in front of the second speaker portions 106a are formed being staggered. For example, as shown in FIG. 14b, the sound radiation holes 106b on the left side are formed in the upper part as seen in FIG. 14b, and the sound radiation holes 106b on the right side are formed in the lower part. With this configuration, the stereophonic sound effect can be obtained.

### Fourth Embodiment

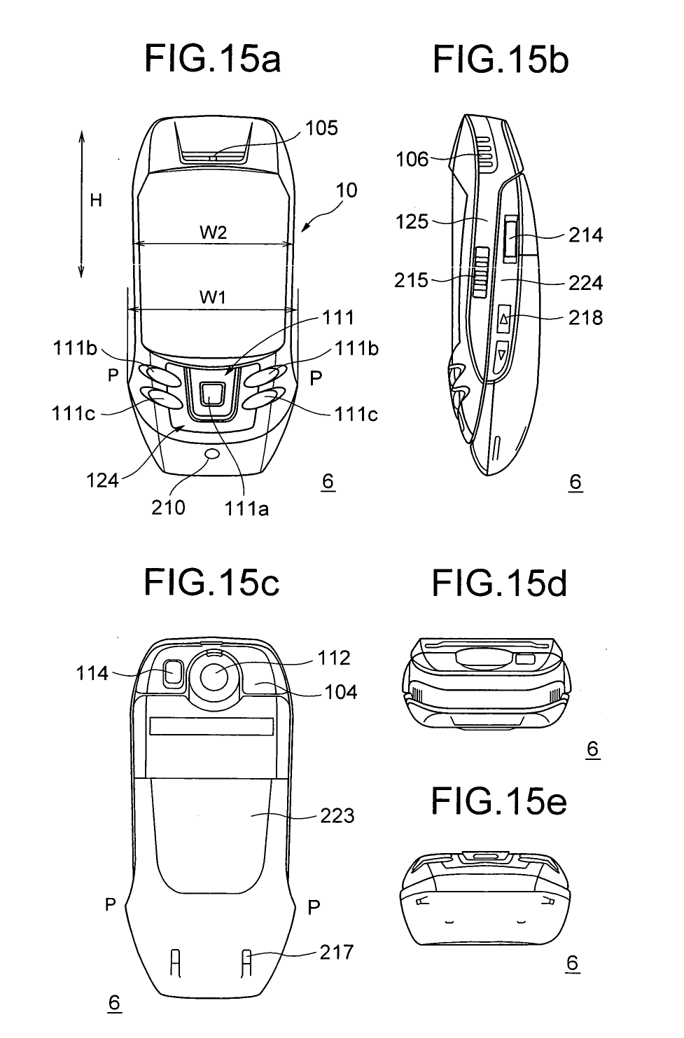

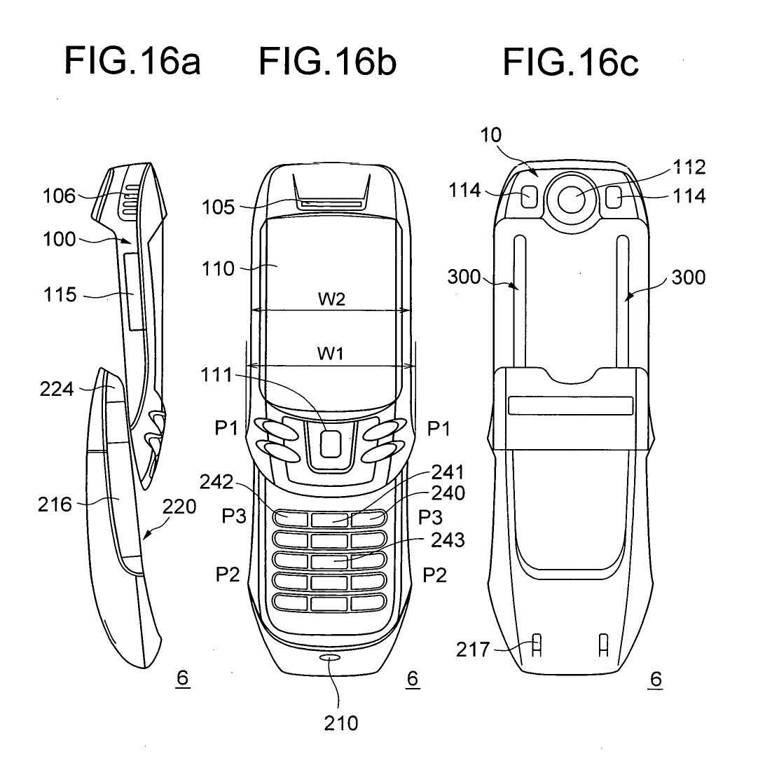

Next, referring to FIGS. 15a to 16c, explanation will be made of a mobile telephone in a fourth embodiment of the present invention with reference to FIGS. 15a to 16c among which FIGS. 15a to 15c are external views illustrating the mobile telephone in the first condition, FIG. 15a being a front view, FIG. 15b a right side view, FIG. 15c a rear view, FIG. 15d a top view and FIG. 15e a bottom view, and further, FIGS. 16a to 16c are external views illustrating the mobile telephone in the second condition, FIG. 16a being a left side view, FIG. 16b a front view and FIG. 16c a rear view. It is noted that like reference numerals denote like parts to those in the above-mentioned embodiments in order to abbreviate duplication of the explanation thereto.

In the configuration of this embodiment, similar to the third embodiment, the first casing 100 and the second casing 200 are superposed with each other with the second casing 200 being located on the rear side of the first casing 100 so that the first casing 100 and the second casing 200 have a fore-and-after relationship. Thereby it is possible to obtain technical effects and advantages similar to those of the third embodiment.

Further, as one of main features of this embodiment, the width W1 of the parts which are always superposed with each other in the first condition is set to be larger than the width W2 of the other parts thereof as viewed in the widthwise W direction. That is, the width W1 of the lower part of the housing 10 is greater than the width W2 of the center part of the housing 10. In the configuration of this embodiment, as shown in FIG. 15a to 15c, the opposite side surfaces of the inclined surface 124 in which the function key board 111 is incorporated are formed so as to be projected from the opposite sides. This projected shape is such that they are angularly extended, having apices P on opposite sides of a substantially center part of the inclined surface 124. In this embodiment, it is concavely curved downward of the housing 10 from the apices P while is convexly curved upward of the housing 10 from the apices P. Since the two casings are always overlapped with each other around the apices P, both casings have such a shape that the lower parts thereof are projected from the opposite sides.

With the mobile telephone 6 having the above-mentioned configuration, as shown in FIG. 16a to 16c, when the two casings are extended from each other in the second condition, parts (around P3) having a narrow width are defined between parts (around P1) which are projected from the lower part of the first casing 100 on the opposite sides, and parts (around P2) which are projected from the lower part of the second casing 200 on the opposite sides.

With this configuration, the user can hold the mobile telephone 6 by nipping the parts (around P3) having a narrow width with the root of a thumb and other fingers. Thus, the mobile telephone 6 can be surely held by one hand through the intermediary of the upward and downward projected parts in the second condition, thereby it is possible to reduce the probability of risk of falling of the mobile telephone 6. Further, with this holding posture, the above-mentioned function key board 111 can be manipulated with the use of the thumb while the housing 10 is surely held.

In addition, the mobile telephone 6 can be stowed in the palm by means of the opposite side projected portions (around P) even in the first condition, thereby it is possible to reduce the risk of falling of the mobile telephone. In addition, in the first condition, the lower part of the housing 10 has a sharpened shape, it can be easily inserted into a pocket.

### Other Embodiments

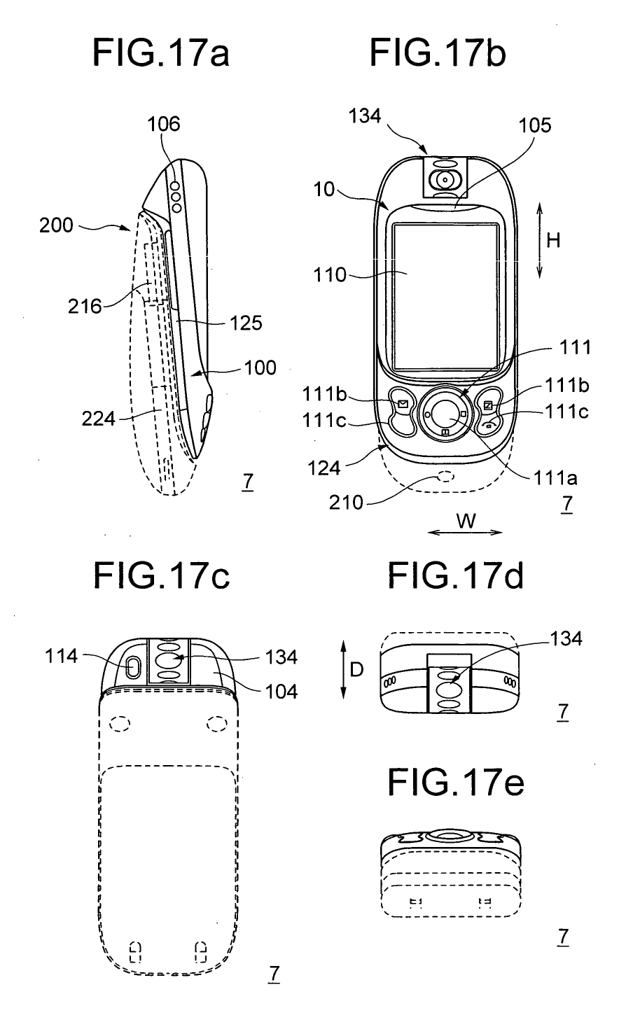

Next, explanation will be hereinbelow made of fifth to eigth embodiments with reference to FIGS. 17a to 24c. The following description will omit duplicate explanation to parts and arrows similar to those explained in the above-mentioned embodiments. In particular, the second casing 200 is similar to that explained in the third or fourth embodiment, and accordingly, it is shown by a dotted line in the drawings, and the explanation thereof will be avoided. That is, in the external views which show the subsequent embodiments, only essential portions (partial designs) are exhibited by solid lines while the parts similar to those explained in the above-mentioned embodiments are exhibited by broken lines. It is noted that the entire configurations consisting of the parts exhibited by the broken lines and the essential parts exhibited by the solid lines are also novel, but such an exhibition is believed to facilitate the understanding of explanation.

### Fifth Embodiment

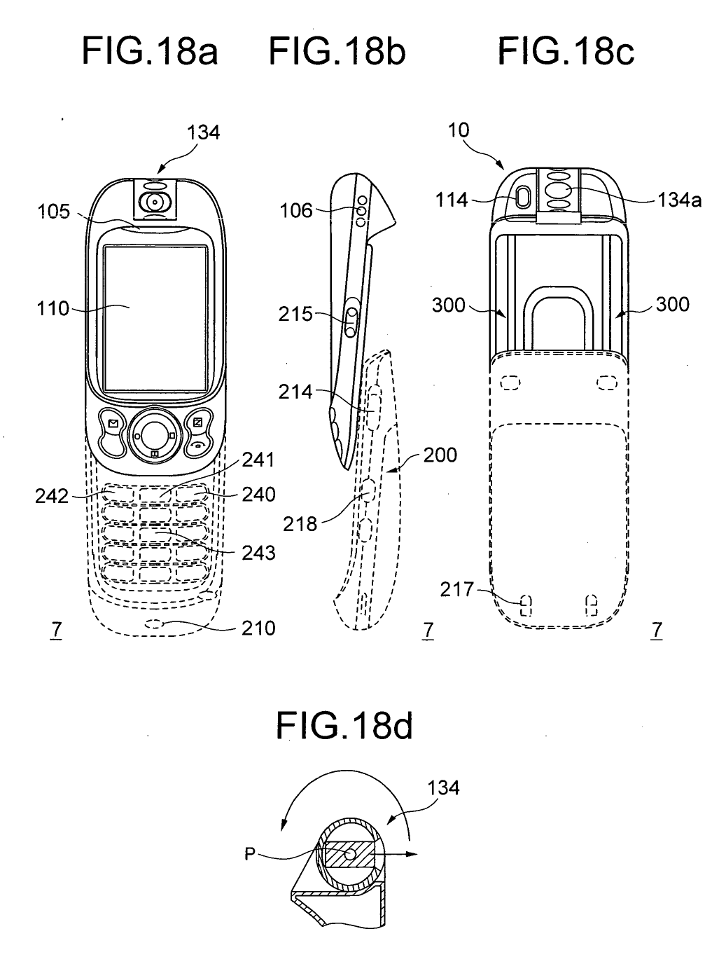

At first, the fifth embodiment of the present invention will be explained with reference to FIGS. 17a to 18d, among which FIGS. 17a to 17e are external views illustrating a mobile telephone in the fifth embodiment in the first condition, FIG. 17a being a left side view, FIG. 17b a front view, FIG. 17c a rear view, FIG. 17d a plan view and FIG. 17e a bottom view, and FIGS. 18a to 18d are external views illustrating the mobile telephone in the second condition, FIG. 18a being a front view, FIG. 18b a right side view, FIG. 18c is a rear view, and FIG. 18d is a longitudinal sectional view illustrating a camera device portion.

Referring to FIG. 17a to FIG. 18d, the mobile telephone 7 in the fifth embodiment, has a configuration similar to that explained in the third embodiment, except a camera device 134 which is rotatably incorporated. Accordingly, technical effects and advantages similar to those explained in the third embodiment can be obtained, except those obtained by the rotatable camera device 134.

This mobile telephone 5 incorporates the camera device 134 in the part 101 of the first casing 100 which is not overlapped with the second casing 200 even in either the first condition or the second condition, and this cameral device 134 is provided so as to be rotatable around a rotary shaft P which is extended in a direction the same as the widthwise W direction of the housing 10.

FIG. 18d is a sectional view illustrating the camera device 134, in this configuration, the user can pick up an image while he monitors the image to be picked up through the above-mentioned display portion 110, and accordingly, an image of his self-portrait can be picked with no erroneous operation. Meanwhile, by rotating the camera device 134 in the direction of the arrow in FIG. 18d, the direction of image pick-up of the camera device 134 can be turned by an angle of 180 deg so as to direct the camera device 134 toward the rear side of the housing 10. In this condition, an image of an object in front of the user is picked up by the camera device 134 while this image is monitored through the display portion 110, thereby it is possible to pick up the image of the object with no erroneous operation.

Thus, in this embodiment, since the camera device 134 is arranged in the part where the two casings are not overlapped with each other even in either the first condition or the second condition, and which can have a large depth D, an image of the self-portrait of the user or an object on the other side can be picked up while the image is monitored through the display portion 110.

It is noted that recesses 134 for receiving finger tips are provided around the cameral device 134 in order to improve slipping during rotation of the camera device 134.

### Sixth Embodiment

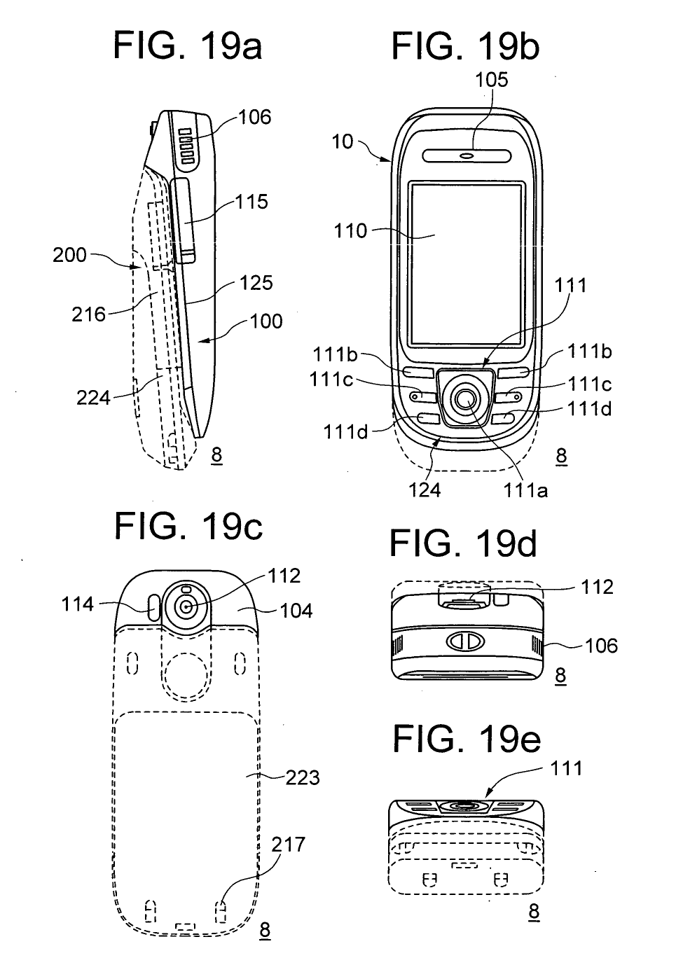

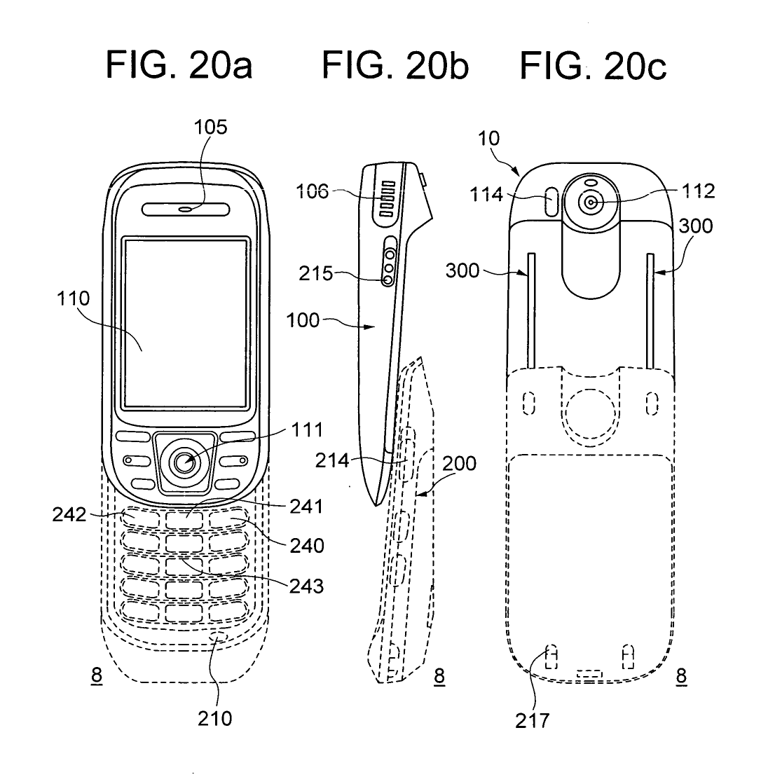

Explanation will be made of a sixth embodiment of the present invention with reference to FIGS. 19a to 20c, among which FIG. 19a to 19e are external views illustrating a mobile telephone in the sixth embodiment in the first condition, FIG. 19a being a left side view, FIG. 19b a front view, FIG. 19c a rear view, FIG. 19d a plan view and FIG. 19e a bottom view, and FIGS. 20a to 20c are external views illustrating the mobile telephone in the second condition, FIG. 20a being a front view, FIG. 20b a right side view and FIG. 20c a rear view.

Referring to FIGS. 19a to 20c, the mobile telephone 8 in the sixth embodiment, has a configuration similar to that explained in the third embodiment, and accordingly technical effects and advantages similar to those obtained in the third embodiment can be obtained.

In this mobile telephone 8, the above-mentioned function key board 111 is composed of a cursor determination key 111a located in the center part having a reverse trapezoidal shape and pairs of selection keys 111b, 111c, 111d located on opposite sides of the former. The cursor determination key 111a has a circular key shape, and by depressing one of ring-like four sides thereof, a cursor displayed on the display portion 110 can be displaced in the depressing direction. Further, by depressing the center thereof, a function allocated to the selected one of various icons and function keys can be carried out.

Meanwhile, the pair of selection keys 111b are for determining functions displayed on the display portion 110, the keys 111c are a menu key and a clear key while the keys 111d are a communication starting key and a communication ending key.

### Seventh Embodiment

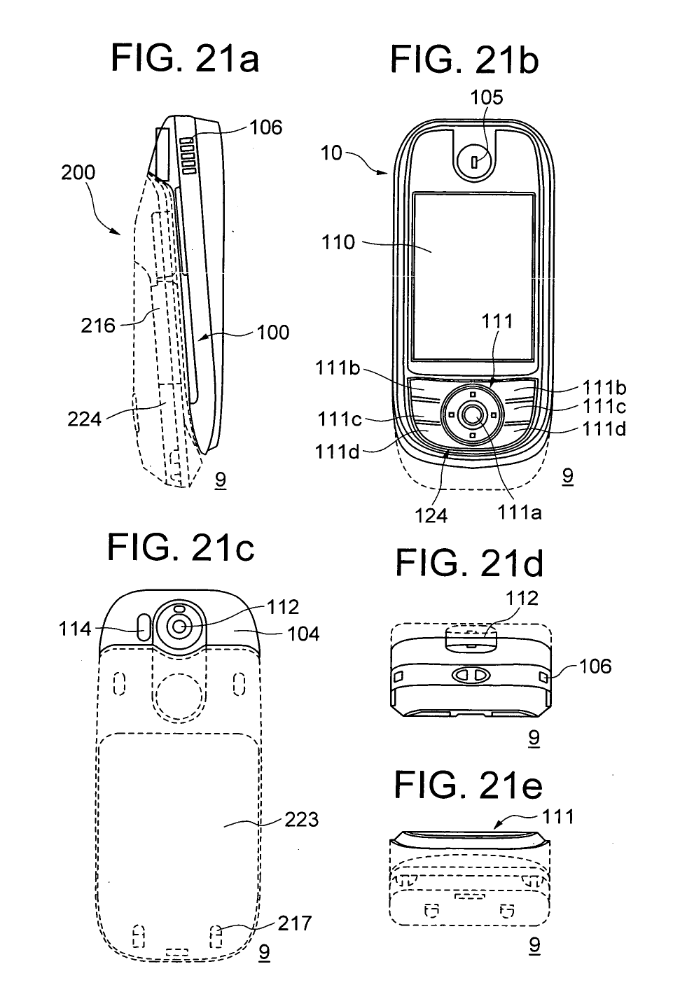

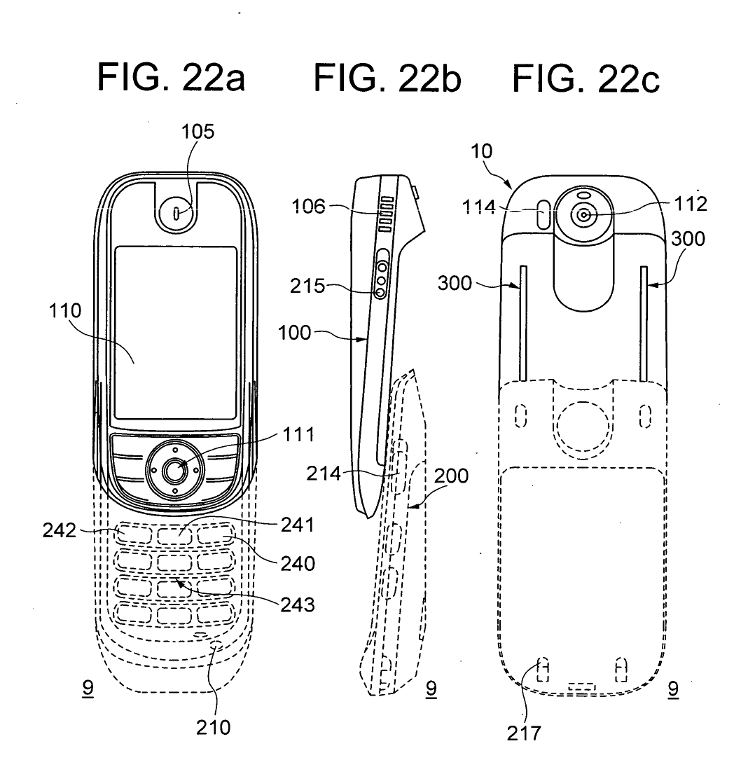

Explanation will be made of a seventh embodiment of the present invention with reference to FIGS. 21a to 22c, among which FIG. 21a to FIG. 21e are external views illustrating a mobile telephone in the seventh embodiment in the first condition, FIG. 21a being a left side view, FIG. 21b a front view, FIG. 21c a rear view, FIG. 21d a plan view and FIG. 21e a bottom view, and FIGS. 22a to 22c are external view illustrating the mobile telephone in the second condition, FIG. 22a being a front view, FIG. 22b a right side view and FIG. 22c a rear view.

Referring to FIGS. 21a to 22a, the mobile telephone 9 in the seventh embodiment has a configuration similar to that explained in the third embodiment, and accordingly, technical effects and advantages similar to those obtained in the third embodiment can be obtained.

In this mobile telephone 9, the above-mentioned function key board 111 is composed of a cursor determination key 111a located in the center, and pairs of selection keys 111b, 111c, 111d formed on opposite sides of the former. The cursor determination key 111a has a circular key shape, and accordingly, by depressing one of ring-like four sides thereof, a cursor displayed on the display portion 110 can be displaced in the depressing direction. Further, by depressing the center thereof, a function allocated to the selected one of various icons and function keys can be carried out.

Meanwhile, each of the above-mentioned selection keys 111b, 111c, 111d has such a configuration that it is coupled to a manipulation board at its center side while it has, on its opposite sides, opened and free ends, and accordingly, by depressing free ends so that the free ends are made into contact with the manipulation circuit board or are returned therefrom with its resiliency, the manipulation can be carried out. It is noted that the function of the mobile telephone in this embodiment is similar to that of the sixth embodiment.

### Eighth Embodiment

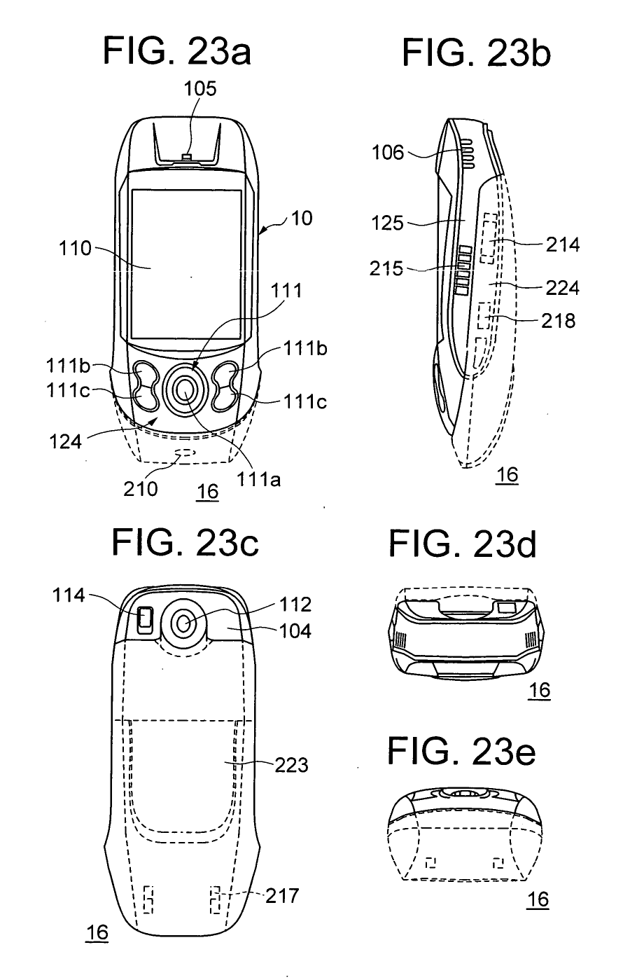

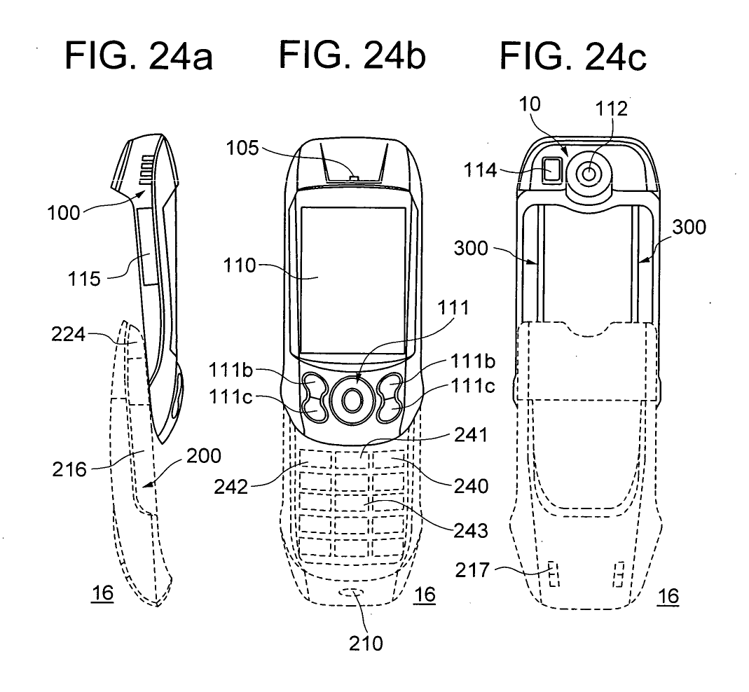

Explanation will be made of an eighth embodiment of the present invention with reference to FIGS. 23a to 24c, among which FIG. 23a to 23e are external views illustrating a mobile telephone in the eighth embodiment in the first condition, FIG. 23a being a front view, FIG. 23b a right side view, FIG. 23c a rear view, FIG. 23d a plane view and FIG. 23e a bottom view, and FIGS. 24a to 24c are external views illustrating the mobile telephone in the second condition, FIG. 24a being a left side view, FIG. 24b a front view and FIG. 24c a rear view.

Referring to FIGS. 23a to 24c, the mobile telephone in the eighth embodiment has a configuration similar to that of the fourth embodiment, and accordingly, technical effects and advantages similar to those obtained in the fourth embodiment can be obtained.

In this mobile telephone 16, the display portion 110 is arranged in at the center of the broad surface (front surface) 103 of the first casing 100, and the function key board 111 is arranged in the inclined surface 124 formed below the display portion 110.

This function key board 111 is composed of a circular cursor determination key 111a located in the center, and pairs of selection keys 111b, 111c around the former.

The cursor determination key 111a has a circular key shape, and accordingly, by depressing one of ring-like four sides thereof, a cursor displayed on the display portion 110 can be displaced in the depressing direction. Further, by depressing one of ring-like four sides thereof, a function selecting screen such as a menu screen can be displayed on the display portion 110. Moreover, by further depressing one of the ring-like four sides thereof, a cursor displayed on the function selecting screen can be displaced in the depressing direction, and further by depressing the center thereof, a function highlighted by the cursor can be carried out.

Meanwhile, functions for carrying out various functions such as an internet function and a mail function are set to the selection keys 11b, 111c, and accordingly, by selecting optional one of the selection keys 111b, 111c, 111d, 111e, a desired function can be carried out.

(Variant Forms)

Although the explanation has been made such that the part 104 and the part 204 of the casings are left on the front surface side and the rear surface side, a part of another casing may be left on only one of the rear surface side and the front surface side.

It should be further understood by those skilled in the art that although the foregoing description has been made on embodiments of the invention, the invention is not limited thereto and various changes and modifications may be made without departing from the spirit of the invention and the scope of the appended claims.

1. A portable terminal unit comprising a first casing, a second casing and a slide mechanism portion for connecting these two casings so that these two casings are slidable in one direction,
wherein the slide mechanism portion connects the first casing and the second casing so that the first casing and the second casing have a fore-and-aft relationship, and are taken in a first condition in which the second casing is superposed with the first casing in rear of the first casing, and in a second condition in which the two casings are displaced from each other in the direction,
the first casing has one end part, in the one direction, which is not superposed with the second casing in the first condition, and a camera portion is rotatably incorporated in this part which is not superposed.

2. A portable data unit as set forth in claim 1, wherein said camera portion is provided so as to rotatable even in any of both first and second conditions.

3. A portable data unit as set forth in claim 1 wherein the camera portion has a peripheral part formed therein with a recess.
